(19) United States
(12) Patent Application Publication
(10) Pub. No.: US 2026/0238983 A1
(43) Pub. Date: Aug. 13, 2026

(54) CONTEXT RENEGOTIATION HANDLING IN SEAMLESS ROAMING IN WLANS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Frisco, TX (US); Vishnu Vardhan Ratnam, Frisco, TX (US); Yue Qi, Plano, TX (US); Bilal Sadiq, Plano, TX (US)

(21) Appl. No.: 19/450,706

(22) Filed: Jan. 15, 2026

Related U.S. Application Data
(60) Provisional application No. 63/755,674, filed on Feb. 7, 2025.
(60) Provisional application No. 63/921,713, filed on Nov. 20, 2025.

(51) Int. Cl. H04W 8/08; H04W 76/15

(52) U.S. Cl. CPC H04W 8/082; H04W 76/15

(57) ABSTRACT

Methods and apparatuses for context renegotiation handling in seamless roaming. A method performed by a non-access point (AP) multi-link device (MLD) of a seamless mobility domain includes determining to roam from a first AP MLD of the seamless mobility domain to a second AP MLD of the seamless mobility domain. The method includes, during roaming from the first AP MLD to the second AP MLD, performing a context renegotiation procedure for renegotiating context that has been setup at the first AP MLD and for setting up renegotiated context at the second AP MLD that is different than the context that has been setup at the first AP MLD.

### CROSS-REFERENCE TO RELATED APPLICATIONS AND CLAIM OF PRIORITY

This application claims priority under 35 U.S.C. § 119 (e) to U.S. Provisional Patent Application No. 63/755,674, filed on Feb. 7, 2025, and U.S. Provisional Patent Application No. 63/921,713, filed on Nov. 20, 2025, each of which are hereby incorporated by reference in their entirety.

### TECHNICAL FIELD

This disclosure relates generally to wireless communication, and more specifically to context renegotiation handling in seamless roaming in Wireless Local Area Networks (WLANs) including next generation WLANs.

### BACKGROUND

Wireless Local Area Network (WLAN) technology allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

Embodiments of the present disclosure provide methods and apparatuses for context renegotiation handling in seamless roaming in WLANs.

In one embodiment, a method performed by a non-access point (AP) multi-link device (MLD) of a seamless mobility domain comprises determining to roam from a first AP MLD of the seamless mobility domain to a second AP MLD of the seamless mobility domain. The method includes, during roaming from the first AP MLD to the second AP MLD, performing a context renegotiation procedure for renegotiating context that has been setup at the first AP MLD and for setting up renegotiated context at the second AP MLD that is different than the context that has been setup at the first AP MLD.

In another embodiment, a method performed by a first AP MLD of a seamless mobility domain comprises receiving an indication that a non-AP MLD of the seamless mobility domain has determined to roam from the first AP MLD to a second AP MLD of the seamless mobility domain. The method includes, during roaming of the non-AP MLD from the first AP MLD to the second AP MLD, performing a context renegotiation procedure for renegotiating context that has been setup at the first AP MLD and for setting up renegotiated context at the second AP MLD that is different than the context that has been setup at the first AP MLD.

In yet another embodiment, an electronic device comprises at least one processor including processing circuitry, and memory storing instructions, where the instructions, when executed by the at least one processor individually or collectively, cause the electronic device to: determine to roam from a first AP MLD to a second AP MLD; and during roaming from the first AP MLD to the second AP MLD, perform a context renegotiation procedure for renegotiating context that has been setup at the first AP MLD and for setting up renegotiated context at the second AP MLD that is different than the context that has been setup at the first AP MLD.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example access point (AP) according to embodiments of the present disclosure;

FIG. 2B illustrates an example station (STA) according to embodiments of the present disclosure;

FIG. 3 illustrates an example request procedure for renegotiation during roaming according to embodiments of the present disclosure;

FIG. 4 illustrates an example response procedure for renegotiation during roaming according to embodiments of the present disclosure;

FIG. 5 illustrates an example procedure for renegotiation with a fallback option according to embodiments of the present disclosure;

FIG. 6 illustrates an example procedure for renegotiation without a fallback option according to embodiments of the present disclosure;

FIG. 7 illustrates an example procedure for enhanced renegotiation with a baseline mechanism according to embodiments of the present disclosure;

FIG. 8 illustrates an example format of a renegotiation indicator according to embodiments of the present disclosure;

FIG. 9 illustrates an example format of a context to renegotiate indication according to embodiments of the present disclosure;

FIG. 10 illustrates an example format of a renegotiation response according to embodiments of the present disclosure;

FIG. 11 illustrates an example procedure for single stage renegotiation according to embodiments of the present disclosure;

FIG. 12 illustrates an example procedure for multiple stage renegotiation according to embodiments of the present disclosure;

FIG. 13 illustrates an example procedure for frame exchanges for renegotiation according to embodiments of the present disclosure; and

FIG. 14 illustrates an example method performed by a non-access point (AP) multi-link device (MLD) in a wireless communication system according to embodiments of the present disclosure.

### DETAILED DESCRIPTION

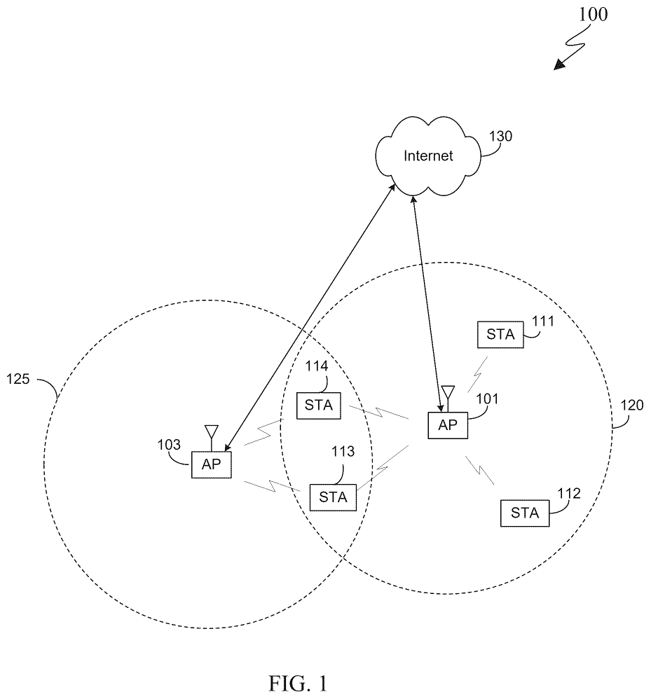

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE P802.11be/D7.0, 2024; [2] IEEE Std 802.11-2020.

Existing WLAN standards support multiple bands of operation, where an access point (AP) and a non-AP device may communicate with each other, called links. Thus, both the AP and non-AP device may be capable of communicating on different bands/links, which is referred to as multi-link operation (MLO). Devices capable of such MLO are referred to as multi-link devices (MLDs).

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating context renegotiation handling in seamless roaming. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

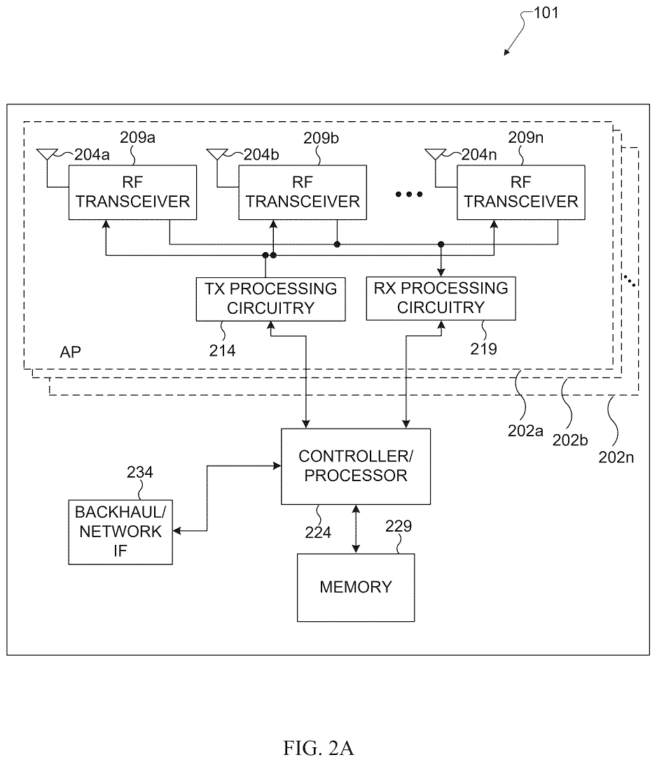

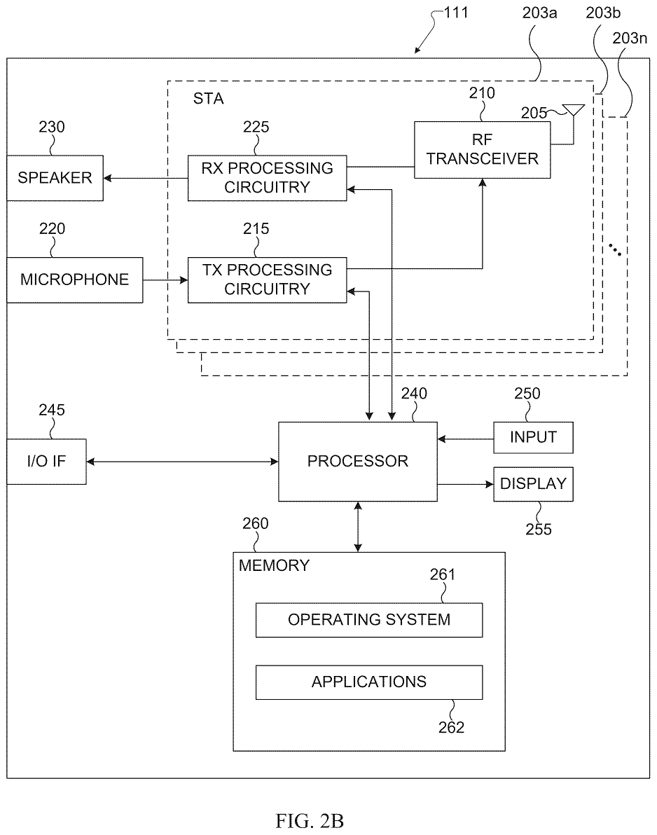

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHZ, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHZ, 5 GHZ, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP MLD 101 by the controller/processor 224 including DL data handling in seamless roaming in WLANs. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for facilitating context renegotiation handling in seamless roaming. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a processor 240, an input/output (I/O) interface (IF) 245, an input 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHZ, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The processor 240 can include one or more processors and execute the basic OS program 261 stored in the memory 260 in order to control the overall operation of the non-AP MLD 111. In one such operation, the processor 240 controls the reception of forward channel signals and the transmission of reverse channel signals by the RF transceiver 210, the RX processing circuitry 225, and the TX processing circuitry 215 in accordance with well-known principles. The processor 240 can also include processing circuitry configured to facilitate context renegotiation handling in seamless roaming. In some embodiments, the processor 240 includes at least one microprocessor or microcontroller.

The processor 240 is also capable of executing other processes and programs resident in the memory 260, such as operations for facilitating context renegotiation handling in seamless roaming. The processor 240 can move data into or out of the memory 260 as required by an executing process. In some embodiments, the processor 240 is configured to execute a plurality of applications 262, such as applications for facilitating context renegotiation handling in seamless roaming. The processor 240 can operate the plurality of applications 262 based on the OS program 261 or in response to a signal received from an AP. The processor 240 is also coupled to the I/O interface 245, which provides non-AP MLD 111 with the ability to connect to other devices such as laptop computers and handheld computers. The I/O interface 245 is the communication path between these accessories and the processor 240.

The processor 240 is also coupled to the input 250 and the display 255. The operator of the non-AP MLD 111 can use the input 250 to enter data into the non-AP MLD 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

Embodiments of the present disclosure recognize that the goal of seamless roaming is to provide mechanisms for a non-AP MLD to transition from a current AP MLD to a target AP MLD such that the time during which the connection is lost is minimal. The seamless roaming procedure can enable a non-AP MLD to remain in state 4 while transitioning from the current AP MLD to the target AP MLD.

The roaming procedure can comprise multiple stages. Two of the stages are a preparation stage and a roam execution/transition stage. During the preparation stage, the non-AP MLD can setup links with the target AP MLD and perform context transfer. Following this stage, the non-AP MLD can perform a roam execution/transition procedure by sending a request frame to transition from the current AP MLD to the target AP MLD. The current AP MLD can process the request frame and send a response frame to the non-AP MLD after the transfer of context is complete.

These procedures can enable the non-AP MLD to seamlessly roam from the current AP MLD to the target AP MLD.

Embodiments of the present disclosure recognize that procedure for handling context renegotiation in next generation WLANs under seamless roaming are needed. Consider a non-AP MLD that has one or more non-AP STAs affiliated with it. The non-AP MLD is capable of associating with an AP MLD with one or more affiliated AP STAs and setup one or more links with the AP MLD. The AP MLD can be a part of a seamless mobility domain (SMD). The SMD can include multiple AP MLDs where the non-AP MLD can perform an SMD basic service set (BSS) transition procedure between the AP MLDs while maintaining association with the seamless mobility domain management entity (SMD-ME). The SMD BSS transition can be a mechanism for a non-AP MLD to transition from its current AP MLD to a target AP MLD without requiring reassociation. Thus, the SMD BSS transition procedure can minimize the time during which the connectivity between the non-AP MLD and the distribution system (DS) is lost. The non-AP MLD can remain in state 4 of association with the SMD-ME during the SMD BSS transition while preserving the context for data transmission. This can result in a seamless experience. The SMD-ME can provide SMD-level authentication and association, IEEE 802.1X authenticator functions and the Robust Security Network Association (RSNA) key management function for non-AP MLDs across all AP MLDs within the SMD. The SMD can have two data path models between the non-AP MLD and the DS. One data path model can be one where a single MAC SAP is used for the SMD. Another data path model can be one which has a separate MAC SAP per AP MLD of the SMD. At a time, only one of the two data paths can be used.

The non-AP MLD can perform an initial association with the SMD-ME through an AP MLD within the SMD. This association can establish an SMD-level security association across all AP MLDs in the SMD. The non-AP MLD can transition between AP MLDs within this SMD while maintaining its association and security association with the SMD-ME.

The non-AP MLD can use mechanisms such as active scanning (e.g., probing, multi-link probe request and response exchanges, etc.), the BSS transition management (BTM) framework, the neighbor report framework for discovery of the neighboring AP MLDs and the SMD BSS transition support by those AP MLDs.

Further, an AP MLD can use the BTM framework to recommend one or more candidate target AP MLDs within the SMD. The current AP MLD can transmit an unsolicited BTM request containing the candidate target AP's information. The non-AP MLD can also request for information on one or more candidate target AP MLDs in the SMD. The non-AP MLD can transmit a BTM query frame to the current AP MLD and request for candidate target AP MLD's information. Thus, the non-AP MLD can discover the capabilities, feature support and constraints at the target AP MLD.

When the non-AP MLD uses SMD BSS transition to transition from an AP MLD (referred to as the current AP MLD without loss of generality) to another AP MLD within the same SMD (referred to as the target AP MLD), the non-AP MLD can perform an SMD BSS transition preparation procedure. The preparation procedure can be performed in advance before the transition occurs. The preparation procedure can be performed by transmitting a preparation request frame to the current AP MLD. Each preparation request can identify a target AP MLD that the non-AP MLD intends to prepare for a transition. Based on the preparation request, there can be a transfer of context related to the non-AP MLD from the current AP MLD to the target AP MLD. Context can be resources or parameters associated with one or more features setup at the target AP MLD. Examples of contexts can be block acknowledgement (BA) setup parameters, stream classification service (SCS), mirrored stream classification service (MSCS), emergency preparedness communication service (EPCS), etc. that are setup at the current AP MLD. Further, the preparation can also allow the non-AP MLD to add one or more links (i.e., form links with APs) with the target AP MLD. The current AP MLD can transmit a preparation response frame that can inform the non-AP MLD about the status of the preparation, the links added and the contexts out of the requested contexts that have been successfully transmitted. Some contexts can be assumed to be transferred even if not explicitly requested by the non-AP MLD.

The target AP MLD can be kept prepared for a certain period of time. Within this period of time, the non-AP MLD can be required to perform an execution procedure to the target AP MLD. If performed outside this period of time, the preparation can be considered as expired resulting in the context and added links getting deleted. In this case, the execution can fail. This period can be referred to as a timeout period in this disclosure.

The execution procedure can either be performed via the current AP MLD or via the target AP MLD. When the execution procedure is performed via the current AP MLD, the non-AP MLD can transmit an execution request frame to the current AP MLD. The current AP MLD can transfer any context that is required to be transferred (e.g., sequence number (SN)) and that is not already transferred to the target AP MLD. The current AP MLD can transfer an execution response frame to the non-AP MLD. When the execution procedure is performed via the target AP MLD, the non-AP MLD can transmit the execution request frame to the target AP MLD. The target AP MLD can then perform the transfer of any context that is required to be transferred and that is not already transferred from the current AP MLD to the target AP MLD. The target AP MLD can transmit an execution response frame to the non-AP MLD.

When a non-AP MLD roams from the current AP MLD to the target AP MLD, the context setup at the current AP MLD can be transferred to the target AP MLD. However, the non-AP MLD can also want to have a different setting at the target AP MLD than what it had at the current AP MLD. Examples of context setup which can be renegotiation can be as described in Table 1.

TABLE 1
Example contexts and their categorization

| Context | Type |
|---|---|
| Sequence Number (SN) | Dynamic |
| Packet Number (PN) | Dynamic |
| Block ACK (BA) parameters. E.g., SN | Dynamic |
| Security keys. E.g., PTKs, GTKs, etc. | Near Static |
| BA setup | Near Static |
| SCS/MSCS | Near Static |
| EPCS | Near Static |
| TWT and variants (restricted TWT, broadcast | Near Static |
| TWT, individual TWT, etc.) | |
| Dynamic Unavailability Operation (DUO) setup, | Near Static |
| Periodic Unavailability Operation (PUO) setup | |
| Power Save: Dynamic SMPS, UPSD, WNM, Intra | Near Static |
| PPDU PS, etc. | |
| EMLSR setup | Near Static |
| EMLMR setup | Near Static |
| PHY Capabilities | Near Static |

For example, the non-AP MLD can have an SCS setup at the current AP MLD. At the time of the setup, the non-AP MLD could have indicated a delay bound of 40 ms in the QoS characteristic IE sent in the SCS request frame. This can be because the non-AP MLD had an application running whose traffic had a delay bound of 40 ms. However, the non-AP MLD may want to change the delay bound and at the time a roam point can be triggered. As a result, the non-AP MLD may want to re-negotiate the delay bound with the target AP MLD to a value different from that agreed with the current AP MLD.

Accordingly, the present disclosure provides mechanisms for handling context renegotiation in next generation WLANs under seamless roaming procedures, including mechanisms for: (1) a renegotiation procedure; (2) renegotiation with a fallback option; (3) renegotiation without a fallback option; (4) enhanced renegotiation using baseline mechanisms; (5) example signaling based on link reconfiguration framework; (6) handling multiple renegotiations; (7) capability advertisement; and (8) example operation.

### 1. Renegotiation Procedure

### 1.a Request Message

According to one embodiment, the non-AP MLD can transmit a renegotiation request message to the target AP MLD. The renegotiation request message can contain at least one or more of the information items as indicated in Table 2.

TABLE 2
Information items that can be present
in the renegotiation request message

| Information items | Description |
|---|---|
| Renegotiation | One or more information items that can indicate |
| indication | that a renegotiation can be performed. Examples |
| | can be as shown in Table 3. |
| Context to | One or more information items that can indicate |
| renegotiation | the contexts that can be renegotiated. For example, |
| | rTWT, SCS, etc. |
| Renegotiation | One or more information items that can indicate the |
| parameters | new values of the parameters. Examples can be as |
| | shown in Table 4. |
| Indication of | One or more information items that can indicate |
| renegotiation | that the renegotiation can be performed with a fall |
| with fallback option | back option. Described in detail in a later section. |
| Indication of | One or more information items that can indicate a |
| renegotiation | renegotiation can be performed without a fallback |
| without a fallback | option. Described in detail in a later section. |
| option | |
| Indication of | One or more information items that can indicate |
| renegotiation | that the non-AP MLD can renegotiate using baseline |
| using baseline | mechanisms. Described in detail in a later section. |
| mechanisms | |

The above message can be incorporated into a single frame or split across multiple frames. In this disclosure, the renegotiation request message can be a preparation request frame or can be carried in a preparation request frame. The renegotiation request message can also be an execution request frame or can be carried in an execution request frame.

TABLE 3
Indication examples

| Example | |
|---|---|
| signaling | Description |
| Bit based | A bit that can take a predetermined value (e.g., 1) to |
| signaling | make the indication and to another predetermined |
| | value (e.g., 0) to indicate otherwise. |
| Implicit | An implicit indication can be made by sending a certain |
| indication | type of frame to the AP MLD. The type of the frame can |
| | indicate that a renegotiation can be performed. |
| Encoding based | A bit based predetermined encoding that can make |
| signaling | the indication and another predetermined encoding |
| | that can indicate otherwise. |

TABLE 4
Example parameters that can be renegotiated for example features

| Example feature | Example parameters |
|---|---|
| Restricted | Target wake time, nominal wake duration, |
| TWT | interval mantissa, interval exponent, etc. |
| SCS | Minimum/maximum service intervals, delay |
| | bound, minimum data rate, mean data rate, etc. |
| DUO | Mode state: enable, disable. |
| PUO | Parameters that characterize the period |
| | unavailability. |

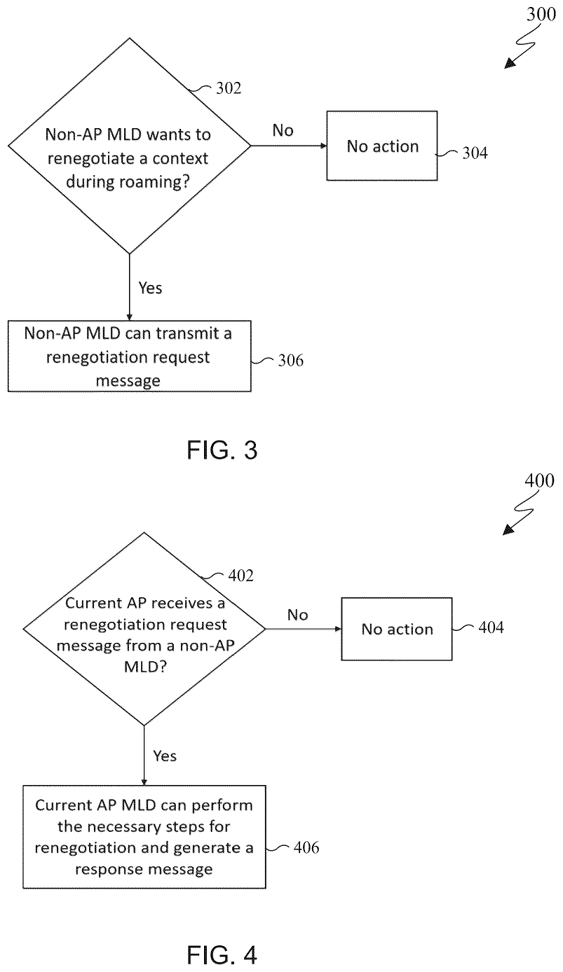

FIG. 3 illustrates an example request procedure 300 for renegotiation during roaming according to embodiments of the present disclosure. The embodiment of the example request procedure 300 for renegotiation during roaming shown in FIG. 3 is for illustration only. Other embodiments of the example request procedure for renegotiation during roaming could be used without departing from the scope of this disclosure.

As shown in FIG. 3, the request procedure 300 begins at step 302, where a determination is made whether the non-AP MLD wants to renegotiate a context during roaming. If the non-AP MLD does not want to renegotiate a context during roaming, then no action is taken at step 304. If the non-AP MLD wants to renegotiate a context during roaming, then at step 306, the non-APLD can transmit a renegotiation request message.

According to one embodiment, the non-AP MLD can transmit this message through the current AP MLD.

According to another embodiment, the non-AP MLD can transmit this message directly to the target AP MLD.

### 1.b Response Message

According to one embodiment, the non-AP MLD can receive a renegotiation response message. The renegotiation response message can contain at least one or more of the information items as indicated in Table 5.

TABLE 5
Information items that can be present
in the renegotiation response message

| Information items | Description |
|---|---|
| Renegotiation | One or more information items that can describe a |
| response | renegotiation response indication. This can indicate |
| indication | to the non-AP MLD whether the renegotiation |
| | occurred successfully or not. Examples can be as |
| | in Table 6. |
| Suggested | One or more information items that can describe |
| parameters | the suggested parameters from the target AP MLD. |
| | E.g., if the target AP MLD rejects the renegotiation |
| | request message, then it can suggest the parameters |
| | that are acceptable to it. The non-AP MLD can setup |
| | using the suggested parameters after renegotiation. |

In this disclosure, the renegotiation response message can be a preparation response frame or can be carried in a preparation response frame. The renegotiation response message can also be an execution response frame or can be carried in an execution response frame.

TABLE 6
Examples of response indication

| Information item | Description |
|---|---|
| Bit based | A bit that can take a predetermined value |
| indication | to indicate success (e.g., 1) and to another |
| | predetermined value (e.g., 0) to indicate failure. |
| Status code | A status code that indicate the status of the |
| | renegotiation request. |
| Encoding based | A bit based predetermined encoding that indicate |
| signaling | success and another encoding that can indicate |
| | a failure. |

FIG. 4 illustrates an example response procedure 400 for renegotiation during roaming according to embodiments of the present disclosure. The embodiment of the example response procedure 400 for renegotiation during roaming shown in FIG. 4 is for illustration only. Other embodiments of the example response procedure for renegotiation during roaming could be used without departing from the scope of this disclosure.

As shown in FIG. 4, the response procedure 400 begins at step 402, where a determination is made whether the current AP receives a renegotiation request message from a non-AP MLD. If the current AP does not receive a renegotiation request message from a non-AP MLD, then no action is taken at step 404. If the current AP receives a renegotiation request message from a non-AP MLD, then at step 406, the current AP can perform the necessary steps for renegotiation and generate a response message.

According to one embodiment, the non-AP MLD can receive this message from the current AP MLD.

According to another embodiment, the non-AP MLD can receive this message from the target AP MLD.

2. Renegotiation with Fall Back Option

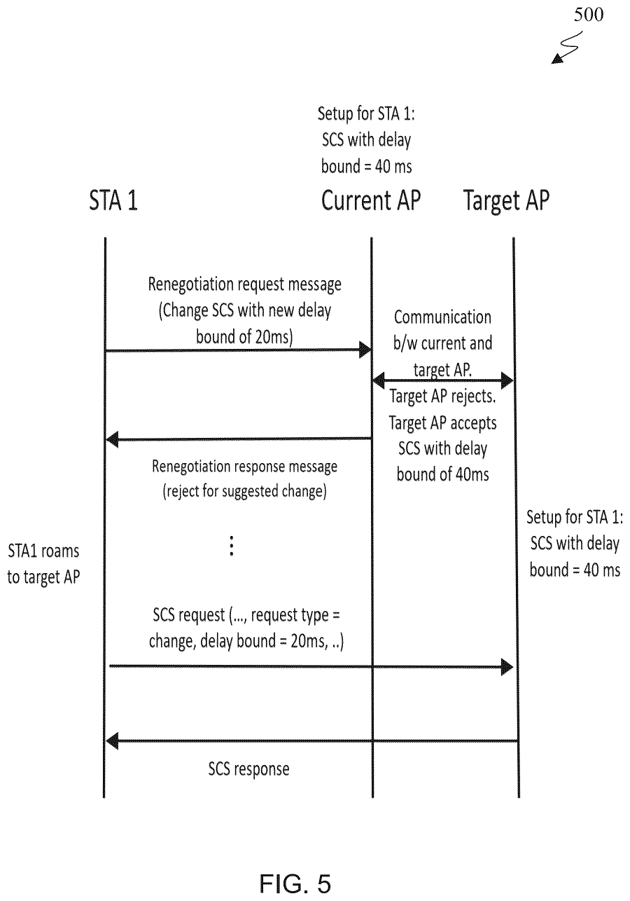

FIG. 5 illustrates an example procedure 500 for renegotiation with a fallback option according to embodiments of the present disclosure. The embodiment of the example procedure 500 for renegotiation with a fallback option shown in FIG. 5 is for illustration only. Other embodiments of the example procedure for renegotiation with a fallback option could be used without departing from the scope of this disclosure.

As shown in FIG. 5, according to one embodiment, a renegotiation can be performed with a fallback option. According to this embodiment, when a context is setup at the current AP MLD, the current AP MLD can perform a context transfer. Further, if the non-AP MLD has provided an indication for a renegotiation, the current AP MLD can attempt to have the new parameters setup at the target AP MLD. If the target AP MLD refuses, the setup can fall back to the old parameters which were transferred from the current AP MLD.

3. Renegotiation without a Fallback Option

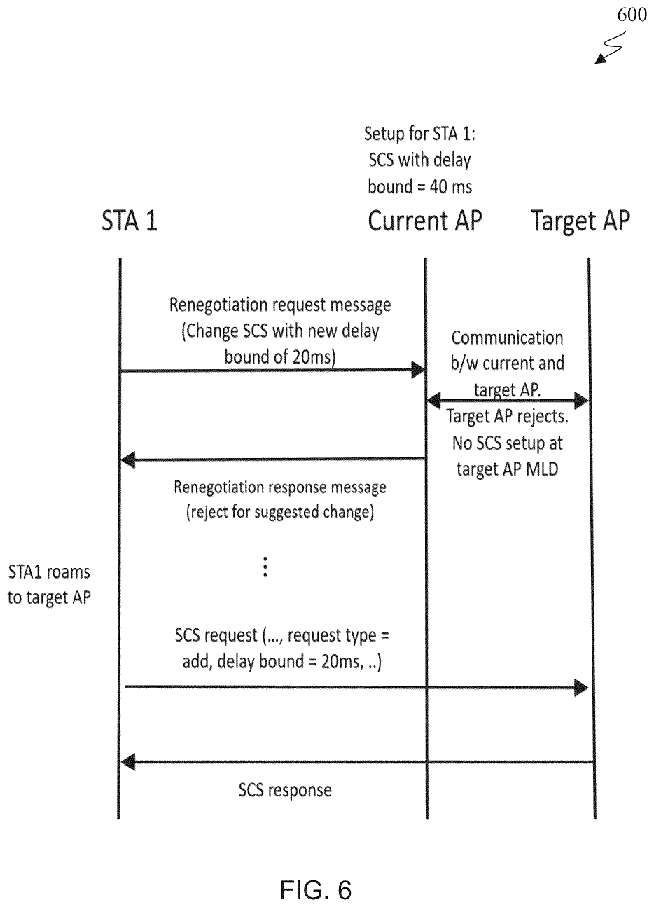

FIG. 6 illustrates an example procedure 600 for renegotiation without a fallback option according to embodiments of the present disclosure. The embodiment of the example procedure 600 for renegotiation without a fallback option shown in FIG. 6 is for illustration only. Other embodiments of the example procedure for renegotiation without a fallback option could be used without departing from the scope of this disclosure.

As shown in FIG. 6, according to one embodiment, a renegotiation without a fallback option can be performed. According to this embodiment, when context is setup at the current AP MLD, the current AP MLD can inform the target AP MLD about the new parameters transmitted by the non-AP MLD. If the target AP MLD rejects the new parameters, then there may not be any setup for that specific context at the target AP MLD and the non-AP MLD can re-setup after roaming with the target AP MLD.

### 4. Enhanced Renegotiation Using Baseline Mechanisms

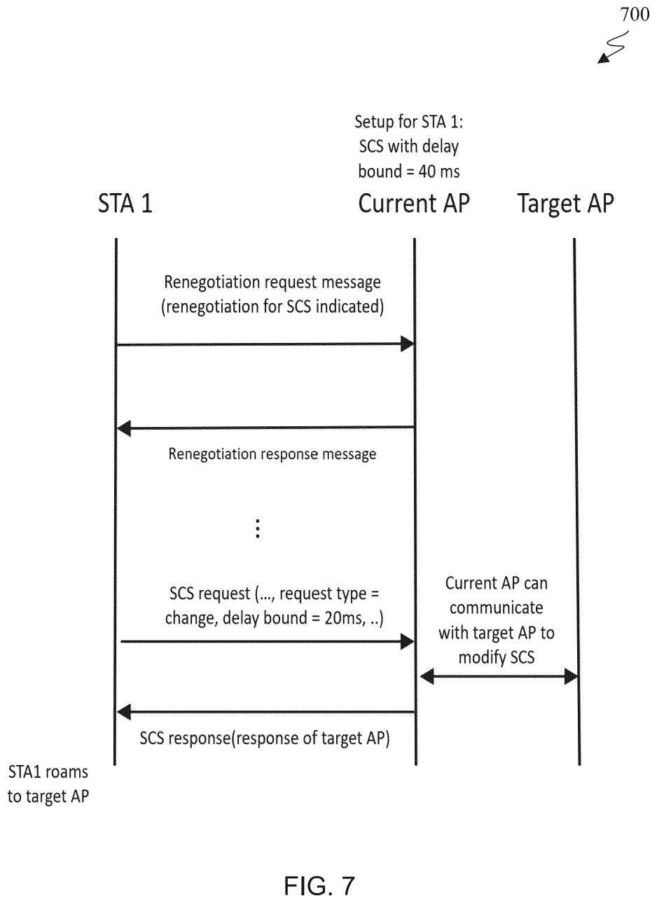

FIG. 7 illustrates an example procedure 700 for enhanced renegotiation with a baseline mechanism according to embodiments of the present disclosure. The embodiment of the example procedure 700 for enhanced renegotiation with a baseline mechanism shown in FIG. 7 is for illustration only. Other embodiments of the example procedure for enhanced renegotiation with a baseline mechanism could be used without departing from the scope of this disclosure.

As shown in FIG. 7, according to one embodiment, an enhanced renegotiation can be performed using baseline mechanisms. According to this embodiment, when the non-AP MLD transmits the renegotiation request message, the non-AP MLD can indicate the feature for which the renegotiation can be performed. Following this indication, the non-AP MLD can re-setup the feature with the current AP MLD using baseline mechanisms. Each time a feature is setup, the current AP MLD can check with the target AP MLD and provide the target AP MLD's response in the baseline response message.

### 5. Example Signaling Based on Link Reconfiguration Framework

### 5.1 Link Reconfiguration Request Frame

According to one embodiment, the renegotiation request message can be made in a link reconfiguration request frame. The link reconfiguration request frame can have a format as shown in Table 7.

TABLE 7
Example modified link reconfiguration
request frame action field format

| Order | Meaning |
|---|---|
| 1 | Category |
| 2 | Protected UHR/EHT Action |
| 3 | Dialog token |
| 4 | Target AP MLD |
| | identifier/Target AP MLD |
| | identifier list |
| 5 | Renegotiation indication |
| 6 | Context to renegotiate |
| 7 | Renegotiation parameters |
| 8 | Reconfiguration Multi-link |
| | element |
| 9 | OCI element |

The order shown in Table 7 can be different than this example. There can be more information items present in the action frame besides the ones mentioned below.

### Target AP MLD Identifier/Target AP MLD Identifier List:

The target AP MLD can be an identifier of the target AP MLD with whom the non-AP MLD can perform renegotiation. For example, the target AP MLD can be a MAC address, a target AP MLD ID, etc. This can also be a list if renegotiation can be performed with multiple AP MLDs.

### Renegotiation Indication

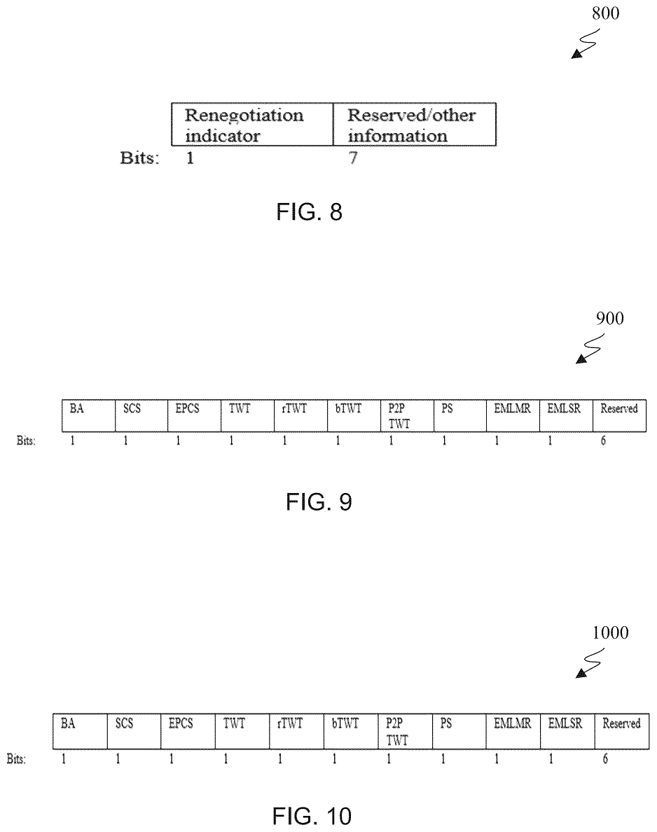

FIG. 8 illustrates an example format of a renegotiation indicator 800 according to embodiments of the present disclosure. The embodiment of the example format of a renegotiation indicator 800 shown in FIG. 8 is for illustration only. Other embodiments of the example format of a renegotiation indicator could be used without departing from the scope of this disclosure.

As shown in FIG. 8, in some embodiments, the format of renegotiation indicator can include a renegotiation indicator field and a field that is reserved or that includes other information. In one example, the renegotiation indicator can take a value of 1 to indicate the non-AP MLD's intent to perform a renegotiation with the target AP MLD by sending the link reconfiguration request frame.

### Context to Renegotiate

FIG. 9 illustrates an example format of a context to renegotiate indication 900 according to embodiments of the present disclosure. The embodiment of the example format of a context to renegotiate indication 900 shown in FIG. 9 is for illustration only. Other embodiments of the example format of a context to renegotiate indication could be used without departing from the scope of this disclosure.

Examples of the context that can be renegotiated are shown in FIG. 9. In one example, the bit corresponding to a feature can take a value of 1 to indicate that the non-AP MLD intends to renegotiate for that feature and take a value of 0 to indicate that the non-AP MLD does not intend to renegotiate for that feature.

### Renegotiation Parameters

In some embodiments, renegotiation parameters can be one or more frames/elements that can carry the new parameters that the non-AP MLD wants to renegotiate. For example, renegotiation parameters can be an SCS descriptor element with a QoS characteristic IE.

### 5.2 Link Reconfiguration Response Frame

According to one embodiment, the renegotiation response message can be carried in a link reconfiguration response frame. The modified link reconfiguration response frame can have a format as shown in Table 8.

TABLE 8
Example link reconfiguration response frame action field format

| Order | Meaning |
|---|---|
| 1 | Category |
| 2 | Protected EHT/UHR Action |
| 3 | Dialog Token |
| 4 | Renegotiation response |
| 5 | Suggested parameters |
| 6 | Count |
| 7 | Reconfiguration Status List |
| 8 | Group Key Data (optional) |
| 9 | OCI element (optional) |
| 10 | Basic Multi-link element |
| | (optional) |

The order shown in Table 8 can be different than this example. There can be more information items present in the action frame besides the ones mentioned below.

### Renegotiation Response

FIG. 10 illustrates an example format of a renegotiation response 1000 according to embodiments of the present disclosure. The embodiment of the example format of a renegotiation response 1000 shown in FIG. 10 is for illustration only. Other embodiments of the example format of a renegotiation response could be used without departing from the scope of this disclosure.

In some embodiments, the renegotiation response can take a format as shown in FIG. 10. A bit corresponding to a feature can take a value of 1 to indicate a successful renegotiation and can take a value of 0 to indicate unsuccessful renegotiation.

### Suggested Parameters

In some embodiments, the suggested parameters can be frames/elements that can carry the suggested parameters. For example, the suggested parameters can be an SCS descriptor element with a QoS characteristic IE with suggested parameters.

### 6. Handling Multiple Renegotiations

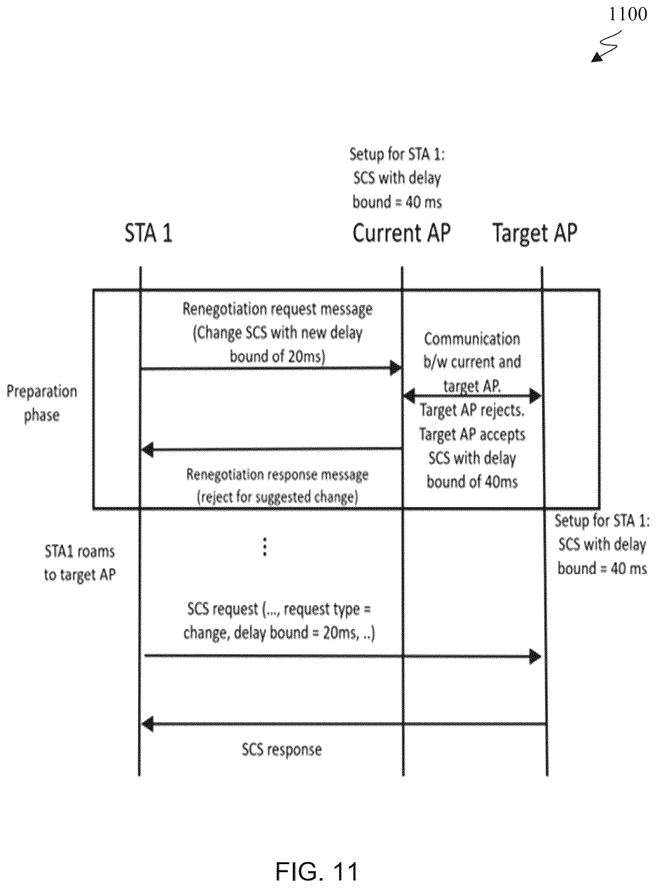

FIG. 11 illustrates an example procedure 1100 for single stage renegotiation according to embodiments of the present disclosure. The embodiment of the example procedure 1100 for single stage renegotiation shown in FIG. 11 is for illustration only. Other embodiments of the example procedure for single stage renegotiation could be used without departing from the scope of this disclosure.

As shown in FIG. 11, according to one embodiment, the renegotiation can be performed once and if there is rejection from the target AP MLD, then the non-AP MLD can perform a setup/renegotiation with the target AP MLD upon roam.

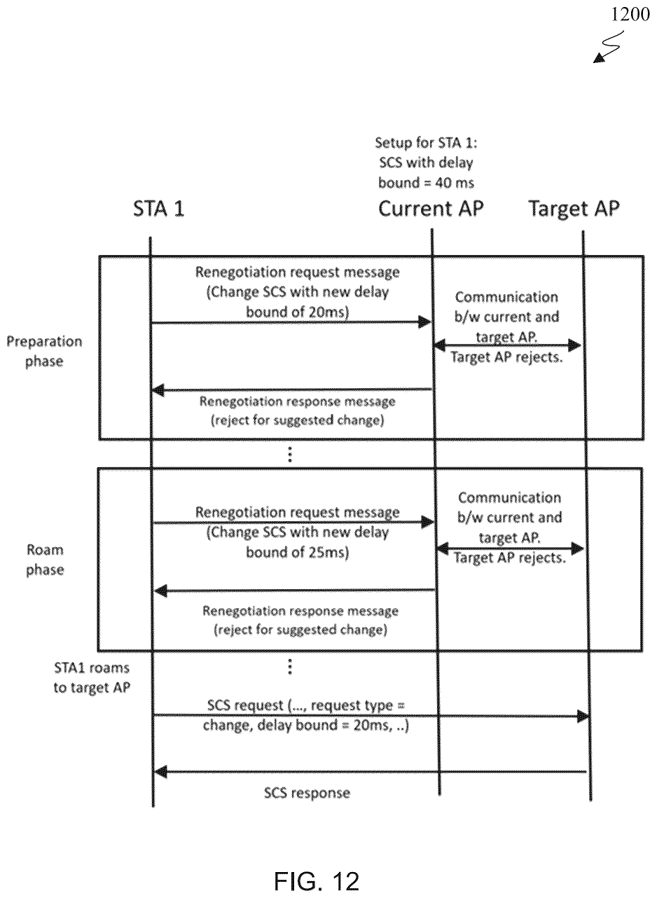

FIG. 12 illustrates an example procedure 1200 for multiple stage renegotiation according to embodiments of the present disclosure. The embodiment of the example procedure 1200 for multiple stage renegotiation shown in FIG. 12 is for illustration only. Other embodiments of the example procedure for multiple stage renegotiation could be used without departing from the scope of this disclosure.

As shown in FIG. 12, according to one embodiment, the renegotiation can be performed in different stages of the roaming procedure. For example, the non-AP MLD can perform one renegotiation at the time of preparation and if the target AP MLD rejects the parameters then it can perform another attempt (possibly with different parameters) at the time of roam execution. If that fails, then the non-AP MLD can perform a re-setup/renegotiation with the target AP MLD upon roam.

### 7. Capability Advertisement

According to one embodiment, a non-AP MLD that supports a renegotiation procedure at the time of roaming can provide an indication of the support in one or more frames that it transmits. For example, the indication can be in the form of a bit that can take a predetermined value (e.g., 1) to make the indication and to another predetermined value (e.g., 0) to indicate otherwise. The indication can be carried in management frames such as probe requests, (re) association requests, etc.

According to one embodiment, an AP MLD/SMD that supports a renegotiation procedure at the time of roaming can provide an indication of the support in one or more frames that it transmits. For example, the indication can be in the form of a bit that can take a predetermined value (e.g., 1) to make the indication and to another predetermined value (e.g., 0) to indicate otherwise. The indication can be carried in management frames such as beacons, probe responses, (re) association responses, etc. The indication can be made via a bit carried in the SMD information element.

According to one embodiment, an AP MLD can also provide an indication of which other AP MLDs in the seamless roaming domain can support renegotiation procedure. For example, the indication can be in the format of a bit corresponding to each of the other AP MLDs that can take a predetermined value (e.g., 1) to make the indication and to another predetermined value (e.g., 0) to indicate otherwise.

The term context can refer to any kind of setup at an AP MLD. It can also refer to any kind of parameters associated with a setup/feature.

The above procedures can be used for multi-link as well as single link operation.

### 8. Example Operation

The following provides example operation by combining one or more embodiments described previously herein.

### 8.1. Example Operation 1

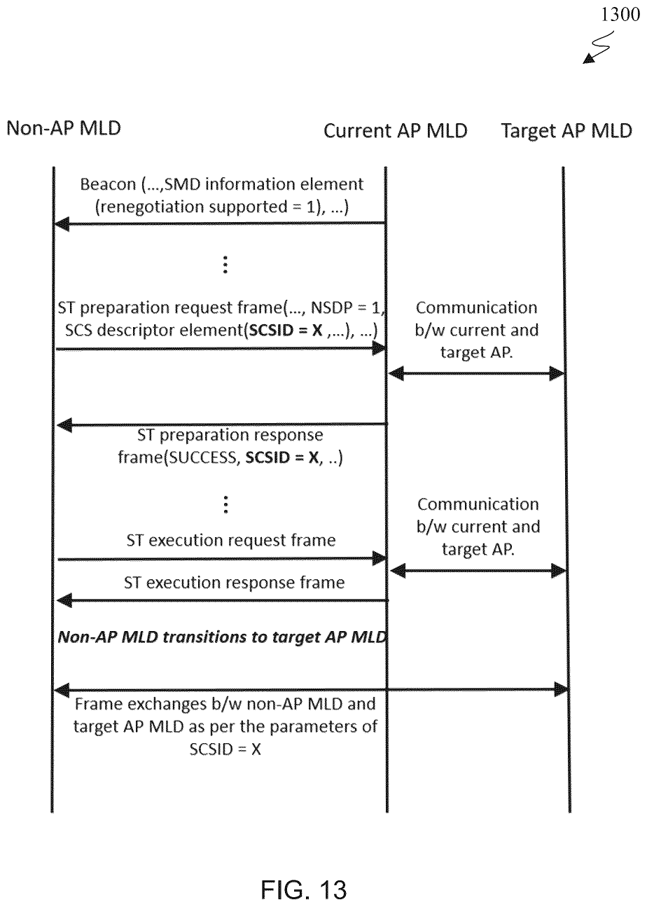

FIG. 13 illustrates an example procedure 1300 for frame exchanges for renegotiation according to embodiments of the present disclosure. The embodiment of the example procedure 1300 for frame exchanges for renegotiation shown in FIG. 13 is for illustration only. Other embodiments of the example procedure for frame exchanges for renegotiation could be used without departing from the scope of this disclosure.

As shown in FIG. 13, in some embodiments, the current AP MLD can advertise a capability to support a renegotiation procedure. The advertisement can also be for the SMD and not for the current AP MLD only. The advertisement can be made by using a bit that is set to a predetermined value (e.g., 1) to make the indication of support and to another predetermined value (e.g., 0) to indicate otherwise.

If there is an indication that the renegotiation procedure is supported, the non-AP MLD when performing preparation can include one or more SCS descriptor elements in the preparation request frame. The SCS descriptor elements can correspond to existing SCS setups and can carry new parameters for those setups or the SCS descriptor elements can correspond to new SCS setups that the non-AP MLD intends to setup at the target AP MLD and can carry parameters corresponding to the new SCS setups. The SCS descriptor elements can also carry one or more QoS characteristic element that describes the QoS profile for the corresponding traffic stream. For instance, the QoS characteristic element can carry the delay bound information for the traffic stream.

There can be a presence bit (for example new SCS descriptor present (NSDP)) in the preparation request frame which can be set to a predetermined value (e.g., 1) to indicate that the SCS descriptor element has been included in the preparation request frame and to 0 to indicate that there are no SCS descriptor elements included in the preparation request frame. If the bit is set to 1, the current AP MLD can parse the preparation request frame to extract the SCS descriptor elements. If set to 0, the current AP MLD does not expect the preparation request frame to carry any SCS descriptor element.

The SCSID corresponding to each SCS descriptor element in the preparation request frame can also be specified in the SCS List field in the ST info field in the SMD BSS Transition Parameters element.

The current AP MLD can process the preparation request frame and can communicate with the target AP MLD (over a backhaul link which can be wired or wireless) to prepare the target AP MLD. The target AP MLD can accept or reject the new SCS descriptors that the non-AP MLD included in the preparation request frame. The target AP MLD can communicate its decision to the current AP MLD over the backhaul. The current AP MLD can generate a preparation response frame and can transmit to the non-AP MLD.

The preparation response frame can carry an SCS list field which can include the SCSIDs corresponding to the SCS descriptor elements (of the SCS flows) that have been accepted by the target AP MLD.

For the SCS descriptor elements that have been accepted by the target AP MLD, the target AP MLD can trigger the non-AP MLD upon transition to the target AP MLD as per the accepted parameters.

For the SCS descriptor elements that have been rejected by the target AP MLD, the non-AP MLD can attempt to set them up again at the target AP MLD upon transition using the same or different parameters (e.g., a different delay bound than what was originally requested in the SCS descriptor element in the preparation request frame).

### 8.2. Example Operation 2

The renegotiation procedure described in this disclosure can be assumed to be supported by the SMD, i.e., there may not be a separate capability indication provided by the current AP MLD. The non-AP MLD can assume that an SMD can support a renegotiation procedure.

Thus, the operation described in example operation 1 above can be carried out even if a capability indication has not been provided regarding the support for a renegotiation procedure.

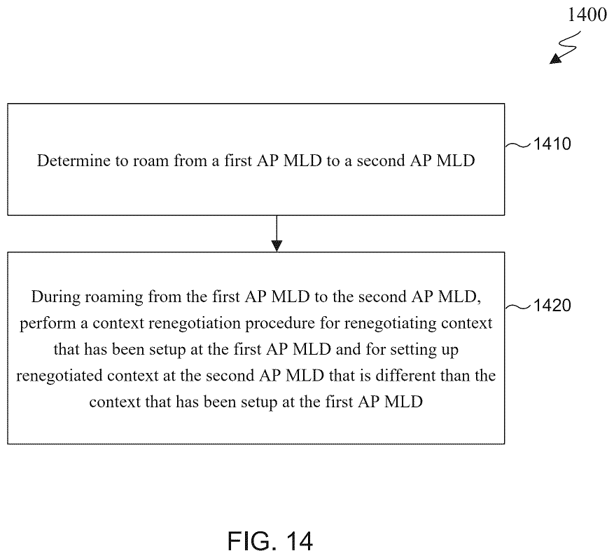

FIG. 14 illustrates an example method 1400 performed by a non-AP MLD in a wireless communication system according to embodiments of the present disclosure. The method 1400 of FIG. 14 can be performed by any of the STAs 111-114 of FIG. 1, such as the STA 111 of FIG. 2B, and a corresponding method can be performed by any of the APs 101-103 of FIG. 1, such as AP 101 of FIG. 2A. The method 1400 is for illustration only and other embodiments can be used without departing from the scope of the present disclosure.

As illustrated in FIG. 14, the method 1400 begins at step 1410, where the non-AP MLD determines to roam from a first AP MLD to a second AP MLD. At step 1420, the non-AP MLD, during roaming from the first AP MLD to the second AP MLD, performs a context renegotiation procedure for renegotiating context that has been setup at the first AP MLD and for setting up renegotiated context at the second AP MLD that is different than the context that has been setup at the first AP MLD.

In some embodiments, the non-AP MLD transmits a renegotiation request message to the first AP MLD or to the second AP MLD indicating that the non-AP MLD wants to renegotiate the context that has been setup at the first AP MLD during roaming; and receives a renegotiation response message from the first AP MLD or from the second AP MLD indicating that context renegotiation is accepted or rejected.

In some embodiments, the renegotiation request message comprises a preparation request frame sent during a preparation stage of the roaming from the first AP MLD to the second AP MLD; and the renegotiation response message comprises a preparation response frame sent during the preparation stage of the roaming from the first AP MLD to the second AP MLD.

In some embodiments, the non-AP MLD transmits the renegotiation request message to the first AP MLD; and the renegotiation response message is received from the first AP MLD indicating that the second AP MLD rejects context renegotiation and accepts the context that has been setup at the first AP MLD.

In some embodiments, the non-AP MLD transmits the renegotiation request message to the first AP MLD; the renegotiation response message is received from the first AP MLD indicating that the second AP MLD rejects context renegotiation; and the non-AP MLD sets up renegotiated context at the second AP MLD after roaming from the first AP MLD to the second AP MLD.

In some embodiments, the renegotiation request message comprises a link reconfiguration request frame sent during a preparation stage of the roaming from the first AP MLD to the second AP MLD; and the renegotiation response message comprises a link reconfiguration response frame sent during the preparation stage of the roaming from the first AP MLD to the second AP MLD.

In some embodiments, the non-AP MLD: transmits a first renegotiation request message to the first AP MLD indicating that the non-AP MLD wants to renegotiate the context that has been setup with the first AP MLD during roaming, wherein the first renegotiation request message indicates a feature for which renegotiation can be performed; receives a first renegotiation response message from the first AP MLD indicating acceptance of the first renegotiation request message; sets up renegotiated context at the first AP MLD with a value of the feature different than a value of the feature in the context that has been setup with the first AP MLD; and receives a second renegotiation response message from the first AP MLD indicating that the renegotiated context is accepted or rejected by the second AP MLD.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by a non-access point (AP) multi-link device (MLD) of a seamless mobility domain, the method comprising:
determining to roam from a first AP MLD of the seamless mobility domain to a second AP MLD of the seamless mobility domain; and
during roaming from the first AP MLD to the second AP MLD, performing a context renegotiation procedure for renegotiating context that has been setup at the first AP MLD and for setting up renegotiated context at the second AP MLD that is different than the context that has been setup at the first AP MLD.

2. The method of claim 1, wherein the context renegotiation procedure comprises:
transmitting a renegotiation request message to the first AP MLD or to the second AP MLD indicating that the non-AP MLD wants to renegotiate the context that has been setup at the first AP MLD during roaming; and
receiving a renegotiation response message from the first AP MLD or from the second AP MLD indicating that context renegotiation is accepted or rejected.

3. The method of claim 2, wherein:
the renegotiation request message comprises a preparation request frame sent during a preparation stage of the roaming from the first AP MLD to the second AP MLD; and
the renegotiation response message comprises a preparation response frame sent during the preparation stage of the roaming from the first AP MLD to the second AP MLD.

4. The method of claim 2, wherein:
the renegotiation request message is transmitted to the first AP MLD; and
the renegotiation response message is received from the first AP MLD indicating that the second AP MLD rejects context renegotiation and accepts the context that has been setup at the first AP MLD.

5. The method of claim 2, wherein:
the renegotiation request message is transmitted to the first AP MLD;
the renegotiation response message is received from the first AP MLD indicating that the second AP MLD rejects context renegotiation; and
the context renegotiation procedure further comprises setting up renegotiated context at the second AP MLD after roaming from the first AP MLD to the second AP MLD.

6. The method of claim 2, wherein:
the renegotiation request message comprises a link reconfiguration request frame sent during a preparation stage of the roaming from the first AP MLD to the second AP MLD; and
the renegotiation response message comprises a link reconfiguration response frame sent during the preparation stage of the roaming from the first AP MLD to the second AP MLD.

7. The method of claim 1, wherein the context renegotiation procedure comprises:
transmitting a first renegotiation request message to the first AP MLD indicating that the non-AP MLD wants to renegotiate the context that has been setup with the first AP MLD during roaming, wherein the first renegotiation request message indicates a feature for which renegotiation can be performed;
receiving a first renegotiation response message from the first AP MLD indicating acceptance of the first renegotiation request message;
setting up renegotiated context at the first AP MLD with a value of the feature different than a value of the feature in the context that has been setup with the first AP MLD; and
receiving a second renegotiation response message from the first AP MLD indicating that the renegotiated context is accepted or rejected by the second AP MLD.

8. A method performed by a first access point (AP) multi-link device (MLD) of a seamless mobility domain, the method comprising:
receiving an indication that a non-AP MLD of the seamless mobility domain has determined to roam from the first AP MLD to a second AP MLD of the seamless mobility domain; and
during roaming of the non-AP MLD from the first AP MLD to the second AP MLD, performing a context renegotiation procedure for renegotiating context that has been setup at the first AP MLD and for setting up renegotiated context at the second AP MLD that is different than the context that has been setup at the first AP MLD.

9. The method of claim 8, wherein the context renegotiation procedure comprises:
receiving a renegotiation request message from the non-AP MLD indicating that the non-AP MLD wants to renegotiate the context that has been setup at the first AP MLD during roaming; and
transmitting a renegotiation response message to the non-AP MLD indicating that context renegotiation is accepted or rejected.

10. The method of claim 9, wherein:
the renegotiation request message comprises a preparation request frame sent during a preparation stage of the roaming from the first AP MLD to the second AP MLD; and
the renegotiation response message comprises a preparation response frame sent during the preparation stage of the roaming from the first AP MLD to the second AP MLD.

11. The method of claim 9, wherein the renegotiation response message indicates that the second AP MLD rejects context renegotiation and accepts the context that has been setup at the first AP MLD.

12. The method of claim 9, wherein:
the renegotiation request message comprises a link reconfiguration request frame sent during a preparation stage of the roaming from the first AP MLD to the second AP MLD; and
the renegotiation response message comprises a link reconfiguration response frame sent during the preparation stage of the roaming from the first AP MLD to the second AP MLD.

13. The method of claim 1, wherein the context renegotiation procedure comprises:
receiving a first renegotiation request message from the non-AP MLD indicating that the non-AP MLD wants to renegotiate the context that has been setup with the first AP MLD during roaming, wherein the first renegotiation request message indicates a feature for which renegotiation can be performed;
transmitting a first renegotiation response message to the non-AP MLD indicating acceptance of the first renegotiation request message;
setting up renegotiated context with the non-AP MLD with a value of the feature different than a value of the feature in the context that has been setup with the first AP MLD; and
transmitting a second renegotiation response message to the non-AP MLD indicating that the renegotiated context is accepted or rejected by the second AP MLD.

14. An electronic device comprising:
at least one processor including processing circuitry; and
memory storing instructions, wherein the instructions, when executed by the at least one processor individually or collectively, cause the electronic device to:
determine to roam from a first access point (AP) multilink device (MLD) to a second AP MLD; and
during roaming from the first AP MLD to the second AP MLD, perform a context renegotiation procedure for renegotiating context that has been setup at the first AP MLD and for setting up renegotiated context at the second AP MLD that is different than the context that has been setup at the first AP MLD.

15. The electronic device of claim 14, wherein the instructions, when executed by the at least one processor individually or collectively, cause the electronic device to:
transmit a renegotiation request message to the first AP MLD or to the second AP MLD indicating that the non-AP MLD wants to renegotiate the context that has been setup at the first AP MLD during roaming; and
receive a renegotiation response message from the first AP MLD or from the second AP MLD indicating that context renegotiation is accepted or rejected.

16. The electronic device of claim 15, wherein:
the renegotiation request message comprises a preparation request frame sent during a preparation stage of the roaming from the first AP MLD to the second AP MLD; and
the renegotiation response message comprises a preparation response frame sent during the preparation stage of the roaming from the first AP MLD to the second AP MLD.

17. The electronic device of claim 15, wherein:
the renegotiation request message is transmitted to the first AP MLD; and
the renegotiation response message is received from the first AP MLD indicating that the second AP MLD rejects context renegotiation and accepts the context that has been setup at the first AP MLD.

18. The electronic device of claim 15, wherein:
the renegotiation request message is transmitted to the first AP MLD;
the renegotiation response message is received from the first AP MLD indicating that the second AP MLD rejects context renegotiation; and
the instructions, when executed by the at least one processor individually or collectively, cause the electronic device to setup renegotiated context at the second AP MLD after roaming from the first AP MLD to the second AP MLD.

19. The electronic device of claim 15, wherein:
the renegotiation request message comprises a link reconfiguration request frame sent during a preparation stage of the roaming from the first AP MLD to the second AP MLD; and
the renegotiation response message comprises a link reconfiguration response frame sent during the preparation stage of the roaming from the first AP MLD to the second AP MLD.

20. The electronic device of claim 14, wherein the instructions, when executed by the at least one processor individually or collectively, cause the electronic device to:
transmit a first renegotiation request message to the first AP MLD indicating that the non-AP MLD wants to renegotiate the context that has been setup with the first AP MLD during roaming, wherein the first renegotiation request message indicates a feature for which renegotiation can be performed;
receive a first renegotiation response message from the first AP MLD indicating acceptance of the first renegotiation request message;
setup renegotiated context at the first AP MLD with a value of the feature different than a value of the feature in the context that has been setup with the first AP MLD; and
receive a second renegotiation response message from the first AP MLD indicating that the renegotiated context is accepted or rejected by the second AP MLD.
